(19) United States
(12) Patent Application Publication
(10) Pub. No.: US 2026/0277495 A1
(43) Pub. Date: Sep. 17, 2026

(54) FLEXIBLE PAPER ATTRIBUTE SELECTION FOR PRINTING OPERATIONS

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 19/078,982

(22) Filed: Mar. 13, 2025

(51) Int. Cl. G06F 3/12

(52) U.S. Cl. CPC G06F 3/1205; G06F 3/1252; G06F 3/1257

(57) ABSTRACT

A printing system includes a printing device having one or more paper trays. A print job is received for the printing device having at least one attribute. A digital front end (DFE) of the printing device parses a print ticket for the print job to determine the attribute. One or more media definitions for papers within the printing system are determined based on the attribute. The media definitions are compared to a paper catalog for the printing device. A list of papers is generated from the paper catalog that supports the media definitions. The DFE determines whether a paper of the list of papers is assigned to a paper tray. The print job is matched to the paper tray and the paper related to the media definitions. The print job is processed using the paper in the paper tray.

### FIELD OF THE INVENTION

The present invention relates to a printing system and associated methods for flexible paper attribute matching to generate a list of papers for printing operations.

### DESCRIPTION OF THE RELATED ART

A difference may exist between how paper is selected by a print shop's customers and how paper is managed by the production printing devices that will produce the items the print shop's customers will purchase. A printing device defines a media or paper catalog that lists dozens if not hundreds of papers. Each of these papers may have well-defined and specific attributes. Conversely, a print shop may define papers using a subset of attributes and more generic attributes. For example, business cards may be defined as “Basic,” “Standard,” “Premium,” and “Deluxe.” These terms may be described as, for example, smooth, middle weight. The intersection between the customer's selection and the actual papers defined at the printing device is not necessarily fixed. The print shop may fulfill these orders with a variety of papers depending on what is available from the paper mills and the current price of the papers.

The print shop may bridge the gap between these selection methods in different ways. The print shop may configure a mapping between individual product descriptions and specific papers. This aspect may be acceptable for print shops that generally order the same paper or for print shops that swap papers seldomly but it does require constant updating of this configuration and the timing has to match the depletion of purchased stock.

The print shop also may extend the above to configure a 1:n mapping between product descriptions and specific papers. The system may need to select a paper before the job is sent to the printing device so there is still need to specify which of the n papers should be used when the job is sent to production. In addition, the operator may need to update these mappings whenever a new paper is purchased. The print shop also may, instead, pass paper attributes to the printing device. The printing device then may select any of the defined papers that match the defined attributes. While these ways may be workable, they also may have some shortcomings. The attributes may match only to papers that are an exact match, which is less flexible versus what print shop may offer.

### SUMMARY OF THE INVENTION

A method for managing printing operations is disclosed. The method includes receiving a print job for a printing device. The print job includes a print ticket. The method also includes determining a plurality of media definitions for the print job from the print ticket. Each media definition of the plurality of media definitions corresponds to an attribute within a paper catalog for the printing device. The method also includes generating a list of papers for the print job from a media catalog for the printing device based on the plurality of media definitions. Each paper includes the respective attribute for the applicable media definition. The method also includes determining a paper of the list of papers to assign to the print job. The method also includes processing the print job using the paper.

In additional embodiments, the method also includes prioritizing the plurality of media definitions. In some embodiments, the step of prioritizing the plurality of media definitions includes assigning a priority to each media definition of the plurality of media definitions. In some embodiments, the step of prioritizing the plurality of media definitions includes prioritizing based on an order of the plurality of media definitions listed in the print ticket. In some embodiments, the method also includes ordering the list of papers according to the priority for the respective media definition. In some embodiments, the step of determining the paper is based on the ordered list of papers.

In additional embodiments, the step of determining the paper includes matching the paper from the list of papers to a loaded paper at the printing device. In additional embodiments, the step of determining the paper includes selecting the paper from the list of papers.

A method for managing printing operations is disclosed. The method includes receiving a print job for a printing device. The print job includes a print ticket having at least one attribute having multiple values. The method also includes determining a plurality of media definitions for the print job from the print ticket. Each media definition of the plurality of media definitions includes a value of the multiple values for the at least one attribute. The method also includes generating a list of papers for the print job from a media catalog for the printing device based on the plurality of media definitions. The method also includes determining a paper of the list of papers to assign to the print job. The method also includes processing the print job using the paper.

In additional embodiments, the method also includes prioritizing the plurality of media definitions. In some embodiments, the step of prioritizing the plurality of media definitions includes assigning a priority to each media definition of the plurality of media definitions. In some embodiments, the step of prioritizing the plurality of media definitions includes prioritizing based on an order of the plurality of media definitions listed in the print ticket. In some embodiments, the method also includes ordering the list of papers according to the priority for the respective media definition. In some embodiments, the step of determining the paper is based on the ordered list of papers.

In additional embodiments, the step of determining the paper includes matching the paper from the list of papers to a loaded paper at the printing device. In additional embodiments, the step of determining the paper includes selecting the paper from the list of papers.

A method for assigning a paper to a print job at a printing device is disclosed. The method includes determining media definitions for the print job based on a print ticket having at least one attribute. The method also includes generating a list of media catalog entries from a paper catalog based on the media definitions for the print job. The method also includes selecting a paper from the list of media catalog entries. The paper includes the at least one attribute. The method also includes assigning the paper to the print job. The method also includes printing the print job at the printing device using the paper.

In additional embodiments, the method also includes prioritizing the list of media catalog entries.

A method for managing printing operations is disclosed. The method includes receiving a print job from a printing device. The print job includes a print ticket having an attribute. The method also includes determining a setting at the printing device related to the attribute. The setting defines multiple values for the attribute. The method also includes determining a plurality of media definitions for the print job from the attribute. Each media definition of the plurality of media definitions includes a value of the multiple values for the attribute defined for the setting. The method also includes generating a list of papers for the print job from a media catalog for the printing device based on the plurality of media definitions. The method also includes determining a paper of the list of papers to assign to the print job.

In additional embodiments, the method also includes processing the print job using the paper of the list of papers.

In some embodiments, the setting is a system setting within the printing device. In some embodiments, the setting is a queue setting. In some embodiments, the multiple values for the attribute are a range of values. In some embodiments, the range of values may be defined by a tolerance based on the attribute. In some embodiments, the multiple values for the attribute include different attribute types.

In additional embodiments, the method also includes prioritizing the plurality of media definitions. In some embodiments, the step of prioritizing the plurality of media definitions includes assigning a priority to each media definition of the plurality of media definitions. In additional embodiments, the step of determining the paper includes matching the paper from the list of papers to a loaded paper at the printing device.

A method for managing printing operations is disclosed. The method includes receiving a print job for a printing device. The print job includes a print ticket having an attribute. The method also includes determining a job setting for the print job related to the attribute. The job setting defines multiple values for the attribute. The method also includes determining a plurality of media definitions for the print job from the attribute. Each media definition of the plurality of media definitions includes a value of the multiple values for the attribute defined by the job setting. The method also includes generating a list of papers for the print job from a media catalog for the printing device based on the plurality of media definitions. The method also includes determining a paper of the list of papers to assign to the print job.

In additional embodiments, the method also includes processing the print job using the list of papers. In some embodiments, a number of the multiple values corresponds to the job setting. In some embodiments, the print ticket includes a job type for the print job that relates to the job setting. In additional embodiments, the method also includes prioritizing the plurality of media definitions. In some embodiments, the step of determining the paper includes matching the paper from the list of papers to a loaded paper at the printing device.

A method for managing printing operations at a printing device is disclosed. The method includes receiving a print job for the printing device. The print job includes a print ticket having a job type. The method also includes associating an attribute to the print job based on the job type. The attribute has multiple values. The method also includes determining a plurality of media definitions of the plurality of media definitions includes a value of the multiple values for the attribute. The method also includes generating a list of papers for the print job from a media catalog for the printing device based on the plurality of media definitions. The method also includes determining a paper of the list of papers to assign to the print job.

In additional embodiments, the method also includes processing the print job using the paper of the list of papers. In additional embodiments, the method also includes prioritizing the plurality of media definitions. In some embodiments, the step of determining the paper includes matching the paper from the list of papers to a loaded paper at the printing device.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1A illustrates a printing system having a printing device for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of a paper catalog for use within the printing system according to the disclosed embodiments.

FIG. 4 illustrates an example listing of attributes for a specific paper according to the disclosed embodiments.

FIG. 5 illustrates a block diagram of using the DFE to generate a list of papers according to the disclosed embodiments.

FIG. 6 illustrates a block diagram of the DFE applying a policy to generate the list of papers according to the disclosed embodiments.

FIG. 7 illustrates a flowchart for configuring the printing device for printing using the list of papers according to the disclosed embodiments.

FIG. 8A illustrates a block diagram of a prioritizing process for media definitions according to the disclosed embodiments.

FIG. 8B illustrates a block diagram of the list of papers according to the disclosed embodiments.

FIG. 9 illustrates a flowchart for using multiple media definitions to determine the list of papers according to the disclosed embodiments.

FIG. 10 illustrates a flowchart for applying a setting or attribute having multiple values to generate the list of papers according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a flexible paper attribute matching system that would address the limitations and constraints in bridging media attribute specifications as understood by print shop customers versus media attribute specifications as they must be defined for production. A variety of processes may be implemented. For example, the disclosed embodiments may extend print ticketing to allow clients to define not one but multiple acceptable papers. The client may include multiple media definitions in the print ticket. The media definitions may be assigned a priority as either an additional attribute or based on the order in which they are listed in the print ticket.

When the print ticket for a print job is received, the job instructions may display the list of acceptable papers for the job. The operator may narrow this list down to one specific paper in the job settings. Alternatively, the operator may leave the ticket as is and simply load one of the acceptable papers. Once one of the papers in the list is loaded in the printing device, the job will match to that paper and from that point onwards, the job will be locked to that paper.

The disclosed embodiments may extend other paper attributes in a similar manner. Numeric attributes may reference an acceptable range instead of a specific value. For example, paper weight may be defined as 100-120 gsm instead of 110 gsm. Enumerated attributes may reference a set of values instead of a specific value. For example, paper coating may be defined as “satin,” “semi-gloss,” “glossy,” instead of “glossy.”

When the print system receives a print ticket with multi-value attributes, it will generate a list of media catalog entries that match one of each of the attribute ranges in the example above. For example, paper 1 may have the values for attributes of 110 gsm, semi-gloss, white, and letter. Paper 2 may have the values for attributes of 110 gsm, glossy, white, and letter. If any of the papers from the list of acceptable papers is loaded, then the job will match to that paper and, from that point onwards, the job will be locked to that paper.

In alternate embodiments, the above tolerances and equivalences may be defined as either system settings or queue settings. Numeric attributes may be defined with a tolerance, such as +/−10 gsm. In this case, a paper that is 100 gsm may match to papers that are 90-110 gsm. Alternatively, these papers may be defined as weight ranges so that a 100 gsm paper may, for example, match papers that are 100-120 gsm. Enumerated attributes may be defined with equivalences. For example, “satin” may be equivalent to “semi-gloss” and “glossy.” In this case, a paper that is “glossy” may match to “satin” or “semi-glossy” papers but not to “high gloss” or “uncalendared” papers.

In some embodiments, these tolerances may be defined, not as global settings or as queue settings, but as attributes that are linked to job types. Job types may be broadly defined as, for example, business cards or postcards. Job types also may be defined more narrowly as basic business cards, standard business cards, premium business cards, or extra thick business cards. The equivalences and tolerances may differ for these different types of jobs so that, for example, the range of papers that would be substituted would be inversely proportional to the quality of the job.

This variation would still have the print ticket include media attributes. In addition, the print ticket would need an indication of the job type. Alternatively, the configuration may be done wholly within the print system so the print ticket need only specify the job type. The disclosed embodiments may be configured with expected attributes and the range of values for the attributes. This feature would allow the ordering system to not consider anything other than the type of job that the customer ordered. Determination of the acceptable range of papers and match to one of those papers would be done completely within the printing system.

The disclosed embodiments provide a printing system that allows the printing device to flexibly bridge the job attributes as known by customers versus the attributes as known by a printing device. By having rules for how attribute values should be handled, the printing system allows the print shop to manage the media catalog by adding or removing papers without worrying about how this would impact the ordering system or without having to continually manage mappings between user-selectable options when ordering and the required details for production.

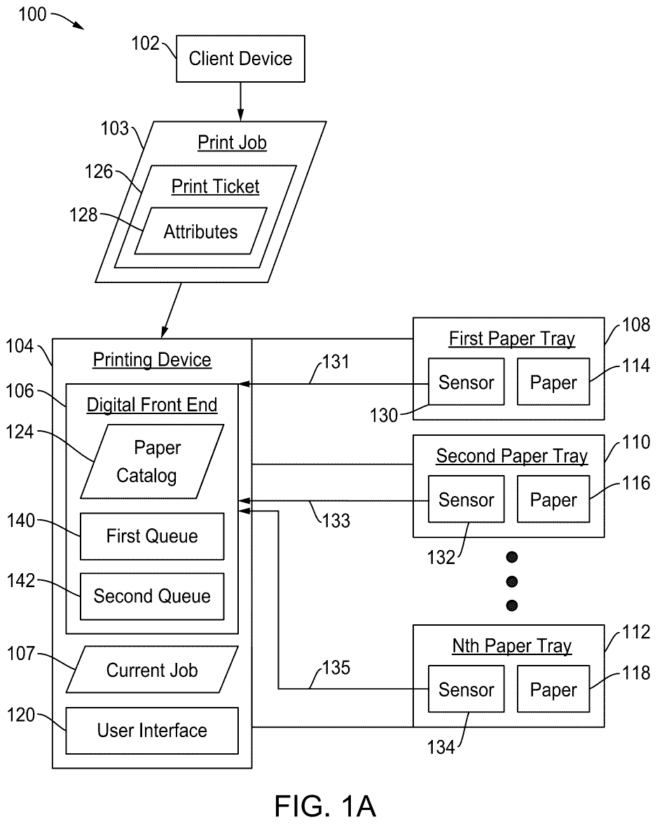

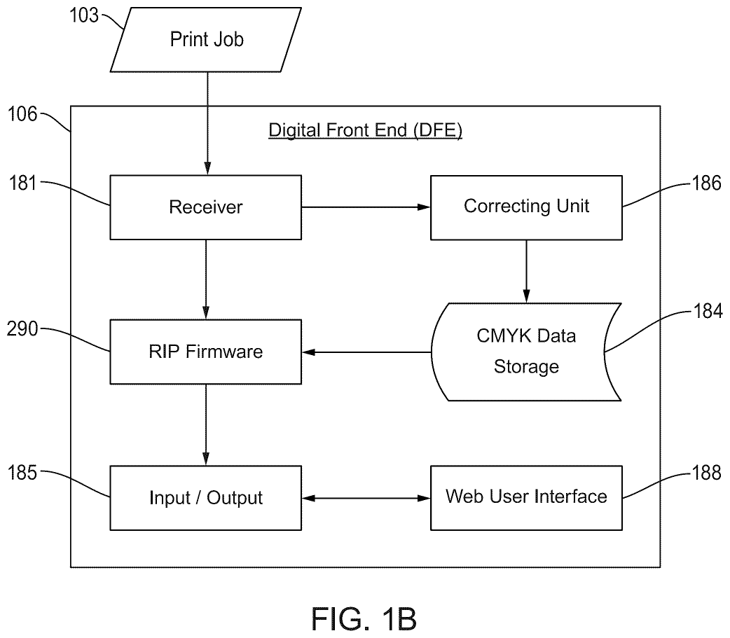

FIG. 1A depicts a printing system 100 for printing documents according to the disclosed embodiments. Printing system 100 includes printing device 104. Printing device 104 is disclosed in greater detail below. Printing device 104 may receive one or more print jobs 103 within printing system 100. For example, client device 102 may generate and send print job 103 to printing device 104. In some embodiments, printing device 104 may be a production printing device in that print jobs are provided through client device 102, which is attached to the printing device. Such a print job may require 1000s of pages or even 100,000 pages or more.

Print job 103 may include a print ticket 126 that sets forth one or more attributes 128 for the print job. For example, print ticket 126 may specify a size for a sheet of print job 103 as well as weight, quality of paper, color of paper, punched holes, and the like. The operator may generate print ticket 126 when submitting print job 103 for printing within printing system 100. Information from print ticket 126, such as one or more attributes 128, may be used to generate a list of recommended papers to display for print job 103.

Printing device 104 may receive print job 103 as it is processing and printing current job 107. Current job 107 may use different paper or media than print job 103. As such, printing device 104 may include a plurality of paper trays to supply papers of various types, sizes, weights, and the like. Thus, printing device 104 includes first paper tray 108 having paper 114, second paper tray 110 having paper 116, and so on to Nth paper tray 112 having paper 118. Current job 107 may use paper from one or more of these paper trays. In some embodiments, paper 114, paper 116, and paper 118 are different types of paper or different media. For example, current job 107 may use paper 116 from second paper tray 110 while print job 103 may require paper 114 from first paper tray 108.

The paper trays may include sensors that detect when the paper trays are opened and closed. This information may be used according to the disclosed embodiments to provide additional functionality in managing paper selection and usage at printing device 104. For example, first paper tray 108 may include first sensor 130. When first paper tray 108 is opened or closed, first sensor 130 may send a signal 131 to DFE 106 informing that the first paper tray is in an open state or a closed state. Second paper tray 110 may include second sensor 132. When second paper tray 110 is opened or closed, second sensor 132 may send a signal 133 to DFE 106 informing that the second paper tray is in an open state or a closed state. When Nth paper tray 112 is opened or closed, Nth sensor 134 may send a signal 135 to DFE 106 informing that the Nth paper tray is in an open state or a closed state.

User interface 120 may be in operation panel 208, disclosed below, or part of digital front end (DFE) 106. DFE 106 is disclosed in greater detail below. DFE 106 may process print jobs and act as a controller for printing device 104. Alternatively, user interface 120 may be displayed on client device 102. The disclosed embodiments may use user interface 120 to select papers for print job 103.

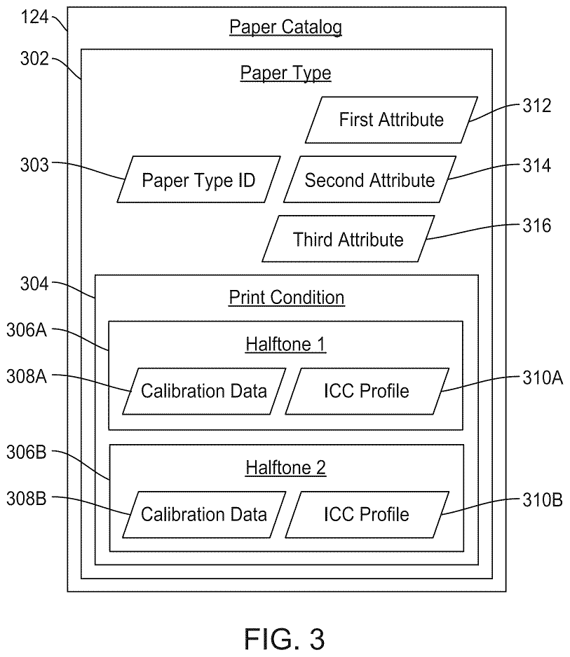

DFE 106 also includes paper catalog 124. Paper catalog 124 is configured to organize and store existing calibration data and ICC profiles for a plurality of papers. Upon selection of a paper for printing at printing device, paper catalog 124 may be accessed to complete print job 103 according to the expectations associated with the print job. Paper catalog 124 is disclosed in greater detail below by FIG. 3. In some embodiments, DFE 106 may include multiple paper catalogs. Further, paper catalog 124 also may be stored in another component within printing system 100 and accessible by DFE 106.

DFE 106 also may include first queue 140 and second queue 142. Print jobs may be placed in the queues for processing in an arranged order. For example, jobs may be queued as first come, first served arrangement. Alternatively, jobs may be ranked according to importance or some other criteria within each queue. The queues may be responsible for different job such that each queue includes its own settings. For example, first queue 140 may related to jobs using first paper tray 108 while second queue 142 may relate to jobs using second paper tray 110. The paper trays may differ as to the types of paper or media loaded in each tray.

FIG. 1B depicts a block diagram of DFE 106 according to the disclosed embodiments. DFE 106 includes a receiver 181, a RIP firmware 290, a CMYK data storage 184, an input/output connector 185, and a correcting unit 186. Additional components within DFE 106 may be implemented, as disclosed above and below.

Receiver 181 receives print job 103 received within system 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing system 100 via input/output connector 185. The print condition information and the print medium type, as well as the rendering data, may be transmitted to a selected printing device within printing system 100. As disclosed above, the rendered data may be in a file format acceptable for a printing device such that the print job is provided directly to the print engine of the printing device.

DFE 106 also includes web user interface 188 that may communicate with other devices within printing system 100, if it is located at a separate device, using, for example, input/output connector 185. Web user interface 188, or web application, allows a user of the DFEs of other printing devices to interact with content or software running on DFE 106.

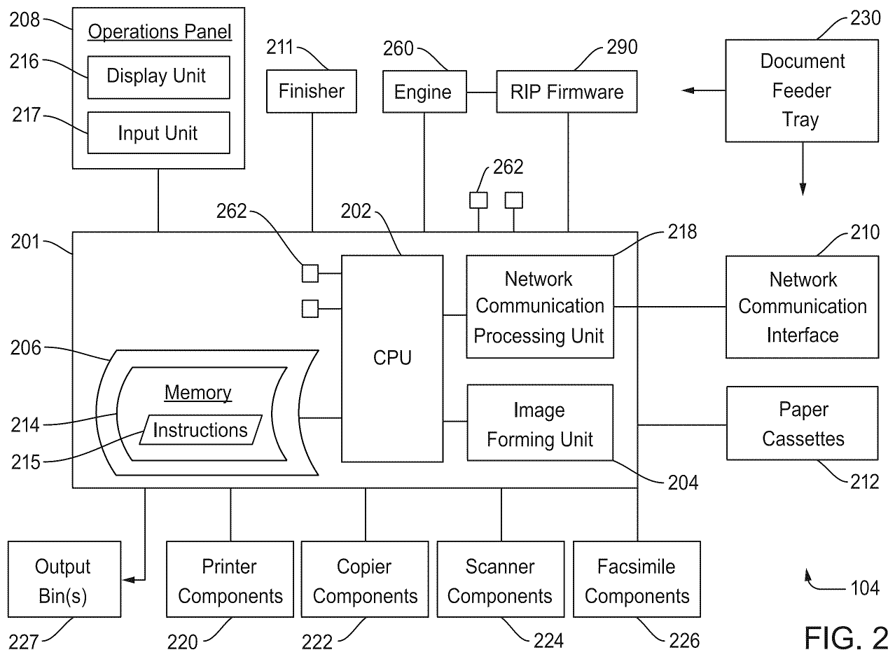

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from DFE 106 and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays, shown as paper trays 108, 110, and 112 in FIG. 1A. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from DFE 106, if applicable. DFE 106 may send calibration and paper catalog information to printing device 104 for display. For example, the operator at DFE 106 may send a calibration to printing device 104. Printing device 104 displays paper type and any other information needed to complete the calibration.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device. Memory unit 206 may store the history of failure events and occurred errors with a timestamp of each error.

Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from DFE 106 as well as other devices within system 100.

FIG. 3 depicts a block diagram of paper catalog 124 for use within printing system 100 according to the disclosed embodiments. As disclosed above, paper catalog 124 may reside within DFE 106 of printing device 104. In other embodiments, paper catalog 124 may reside in another component within printing system 100, such as client device 102 or an external server. For brevity, paper catalog 124 is disclosed below as residing within DFE 106.

For each paper type used for a particular model of printing device 104, there are a set of items that work together to achieve optimal reproduction capabilities. These items may be represented in paper catalog 124. An example of an entry in paper catalog for a paper type 302 may be shown. Paper catalog may include hundreds or thousands of such entries. Paper type 302 may be identified within paper catalog 124 by paper type identification 303. In some embodiments, paper type identification 303 may be a unique symbol or code that identifies paper type 302 within paper groups, disclosed in greater detail below.

Paper type 302 includes print conditions. Print conditions may be applied to print jobs using paper type 302. Examples of print conditions may be high quality, default, economy, ink saving, and the like. Each print condition may include its own color printing resources, such as calibration data and ICC profiles. Application of a print condition results in a different result for a print job using paper type 302 at printing device 104. For example, a high quality print condition will differ in some fashion as a finished, printed document from one printed using the default print condition.

As shown in FIG. 3, paper type 302 may include print condition 304. It also may include additional print conditions. Print condition 304 may relate to the high quality print condition for printing paper type 302 at printing device 104. Within print condition, halftones, or halftone designs, may be defined. Printing device 104 may have one or more halftones. Halftones are binary on/off dot patterns of each ink to mimic continuously varying transitions. One halftone could emphasize details in the image, while another could be best for smooth transitions. Thus, print condition 304 includes halftone 306A and halftone 306B. For example, halftone 306A may correspond to the halftone design to emphasize details in the image being printed. Halftone 306B may correspond to the halftone design to provide for smooth transitions.

For each halftone, the print shop should capture the desired per-colorant behavior over all shades of that colorant. By behavior, the disclosed embodiments refer to the color measurement. The record of these colorant behaviors, and the information that allows printing device 104 to be adjusted back to such behaviors, are stored as calibration data. These adjustments may vary linearly or with a curve. The calibration data include characteristics of each ink under the halftone selected. Thus, halftone 306A includes calibration data 308A and halftone 306B includes calibration data 308B.

Further, with a selected halftone, and the calibration data enforced to produce desired behavior of each colorant, the disclosed embodiments then create an ICC profile to fully characterize how ink combinations relate to standardized color measurements, as disclosed above. It is via the ICC profile that, for the specific paper-halftone-calibration-data set up, printing device 104 can reproduce the colors, text, and attributes of the original document. The process for generating an ICC profile is disclosed above. Thus, halftone 306A includes ICC profile 310A and halftone 306B includes ICC profile 310B.

More specific customizations may be identified as print conditions. In the scheme of the items affecting color management, the disclosed embodiments place print conditions at the highest tier under each paper type, as shown in FIG. 3 by print condition 304.

Paper type 302 along with print condition 304 and halftones 306A and 306B may refer to the print management resources and items for one paper type. In a print shop, for each model of printing device 104, there may be dozens or more paper types in use. To keep track of the print management items for all these papers, paper catalog 124 may be implemented in system 100. As disclosed above, paper catalog 124 may be a software data storage system that archives all the color management items and resources for each paper type in use. When a print job is specified on a particular paper, identified as paper type identification 303, under a chosen print condition 302 employing halftone 306A, paper catalog 124 will provide the proper corresponding calibration data 308A and ICC profile 310A for printing device 104 to use. If the print job specifies print condition 302 employing halftone 306B, then paper catalog 124 will provide calibration data 308B and ICC profile 310B for printing device 104 to use for the print job.

Paper type 302 also may include one or more attributes for the paper. For example, first attribute 312 may be the weight of a sheet of paper type 302. First attribute 312 may be 120 grams per square meter (gsm). Heavier paper is reflected by a higher number for gsm. Generally, heavier paper is associated with a higher quality of stock. It should be noted that dimensions may also be considered an attribute of paper type 302. Further, first attribute 312 may be considered a dimension of paper type 302.

Paper type 302 also may include second attribute 314 and third attribute 316. These attributes may pertain some other feature of the paper of paper type 302 aside from dimensions and weight. Second attribute 314 may refer to the color of the paper for paper type 302, such as white, blue, yellow, and the like. Third attribute 316 may refer to a feature of the paper of paper type 302, such as recycled, new, and the like. Other potential attributes may be glossy or matte paper.

Dimensions and attributes within paper catalog 124 may not necessarily match the attributes for paper trays 108, 110, and 112. Paper trays 108, 110, and 112 also may have attributes that apply to print job 103 as specified by print ticket 126. Dimensions may be included in print ticket 126. Dimensions also may apply to an attribute within paper catalog 124 and paper trays 108, 110, and 112. The other attributes, however, within paper catalog 124 may not apply to any attribute for paper trays 108, 110, and 112.

In some embodiments, calibrations and ICC profiles may be listed in a paper catalog entry 302 but not associated with a print condition. Further, additional print conditions may be listed for each entry. In other words, the print condition may be null within paper catalog entry 302. For example, paper catalog entry 302 may include print condition 304 as disclosed above. It also may include another set of calibration and ICC profile data, such as calibration 308A or 308B and ICC profile 310A or 310B, that is not associated with a print condition.

Paper catalog entry 302 also may include a second print condition that uses a different calibration but perhaps the same ICC profile as the sets not corresponding to a print condition. Further, paper catalog entry 302 may include another group of printing resources for halftone 306B but this is not related to a print condition and includes its own calibration and ICC profile. In other words, printing resources may be listed in a paper catalog entry 302 in a number of ways. Multiple calibrations and ICC profiles may be tied to an entry. The calibration and ICC profiles may still be tied to the integrated resource management operations disclosed herein.

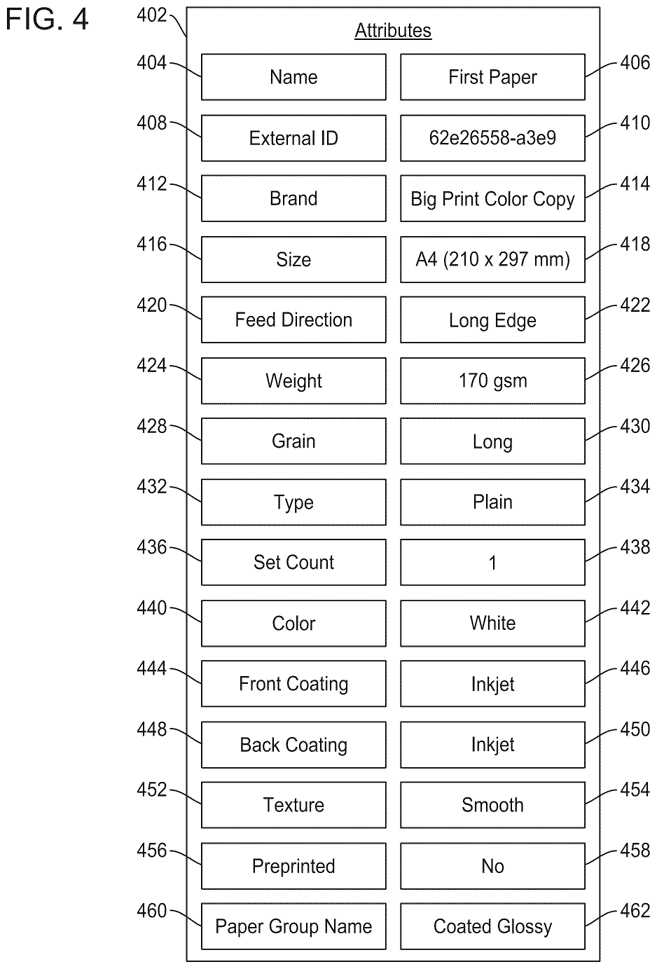

These features may be disclosed in greater detail by FIG. 4. FIG. 4 depicts an example listing of attributes 402 defined for a job, such as print job 103, according to the disclosed embodiments. Attributes 402 of FIG. 4 may correspond to attributes 312, 314, and 316 in FIG. 3. For example, attribute 312 may correspond to any one of attributes 402. Attributes 402 may be listed in paper catalog entry 302 for a paper, or may be a file associated with the paper. FIG. 4 may show how attributes 402 are displayed for a selected paper in user interface 120. For example, an operator may click on an entry for the paper in paper catalog 124 within user interface 120 to display its attributes 402.

Name attribute 404 may refer to the name given for the paper in paper catalog 124, at printing device 104, or within printing system 100. Value 406 may be a field with the name, such as First Paper for the paper. External identification attribute 408 may refer to an external identification number or code for the paper. Value 410 may be a field with the code. Here, the code may be 62e26558-a3e9. Brand attribute 412 may be the brand name for the first paper. Many paper manufacturers have their own names for their papers. For example, Big Print Company may make the first paper with a brand name of Big Print Color Copy. Thus, value 414 may be a field having Big Print Color Copy.

Size attribute 416 may refer to the size of the paper. Size attribute 416 may correspond to dimensions of the paper. Value 418 may be A4, which is a common reference to a paper size used in printing operations. Other data for value 418 may be letter, legal, A3, or A5. Value 418 also may include the actual dimensions, for example, 210 mm by 297 mm.

Feed direction attribute 420 may refer to the direction that the first paper is fed within printing device 104. Value 422 may include long edge as the feed direction. Weight attribute 424 may refer to the weight of the first paper. Value 426 may be the weight in grams per square meter, or gsm. Here, value 526 is 170 gsm. Grain attribute 428 may refer to the grain used by the first paper. Value 430 may be, for example, long for a long grain.

Type attribute 432 may refer to the paper type for the first paper. Value 434, for example, may be plain in that the first paper is a plain type. Set count attribute 436 may refer to the set count used for the first paper. Value 438, for example, may be 1. Color attribute 440 may refer to the color of the first paper. Value 442, for example, may be white in that the first paper is white.

Front coating attribute 444 may refer to the coating of the front of the first paper. Value 446, for example, may be inkjet, as opposed to toner or laser, to indicate that the first paper is to be used in inkjet printing devices. Back coating attribute 448 may refer to the coating of the back of the first paper. Value 450, for example, also may be inkjet. Texture attribute 452 may refer to the texture, or feel, of the first paper. Value 454, for example, may be smooth to indicate that the first paper has a smooth texture. Preprinted attribute 456 may refer to whether the first paper is preprinted before being loaded onto printing device 104. Value 458, for example, is no.

Paper group name 460 may refer to a paper group that includes the first paper. The paper group may be generated using one or more attributes 402 in papers within paper catalog 124. Not every paper within the paper group may have all the attributes of the first paper. Here, value 462 for the paper group name may be coated glossy. The coated glossy paper group may be made available to the operator via user interface 120 for selection to export or import. If the first paper is selected to export, then the disclosed embodiments also may provide a first set of papers, or coated glossy, for selection to export. In some embodiments paper group name 460 may be an attribute.

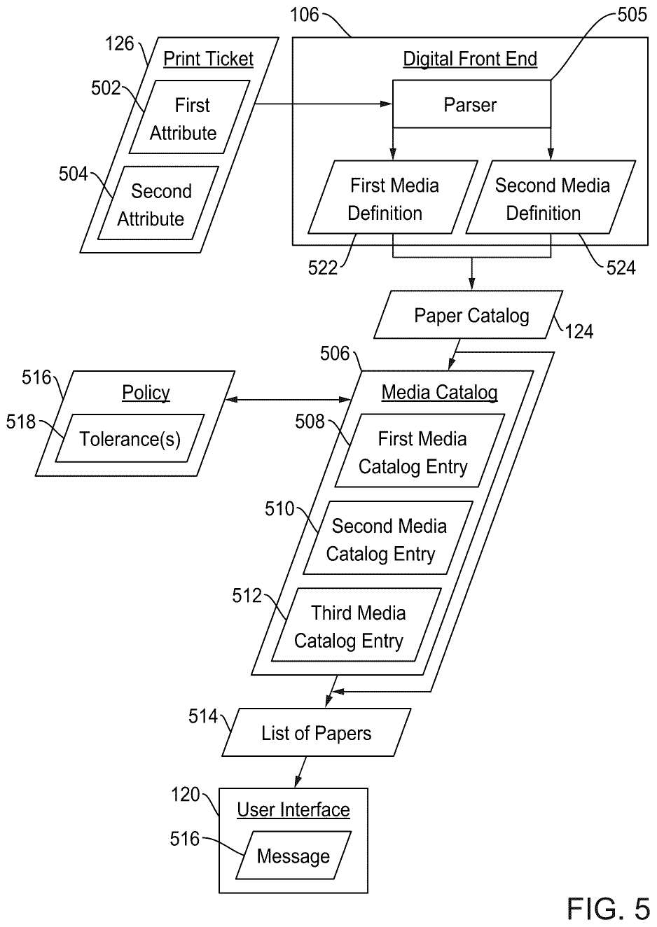

FIG. 5 depicts a block diagram of using DFE 106 to generate a list of papers 514 according to the disclosed embodiments. Printing system 100 receives print job 103 having print ticket 126. As disclosed above, print ticket 126 includes attributes 128. These attributes may include first attribute 502 and second attribute 504. An attribute may relate to the type of media desired for print job 103, such as paper type, size, weight, finish, and the like. One attribute may relate to a paper tray configuration.

An upstream client defines the media using any supported attributes. The upstream client may use client device 102 to generate and submit print ticket 126 with a print job 103. Client device 102 submits print job 103 and print ticket 126 with attributes 128 to DFE 106. Attributes 128 would include first attribute 502 and second attribute 504. DFE 106 parses using parser 505 to identify first attribute 502 and second attribute 504. Thus, DFE 106 identifies first attribute 502 and second attribute 504 to apply against paper catalog 124 using corresponding media definitions.

DFE 106 also determines a plurality of media definitions for print job 103. Each media definition corresponds to an attribute within paper catalog 124. For example, first media definition 522 may be determined based on first attribute 502 from print ticket 126. First attribute 502 may relate to paper weight, and have values such as “Deluxe” or “heavy” while first media definition 522 may be actual a weight or range of weights for such papers. Second media definition 524 may be determined based on second attribute 504 from print ticket 126. Second attribute 504 may relate to paper size, and have values such as “letter” or “legal.” Second media definition 524 may be the actual sizes, such as 8.5″ by 11″, for the values. Media definitions may have values that are open or closed, wherein closed refers to a specified number or types of values that may be used for the media definition.

In some embodiments, media definitions may be defined by print ticket 126. The operator or customer may define first media definition 522 and second media definition 524 using instructions for print ticket 126. Parser 505 may identify first media definition 522 and second media definition 524 from print ticket 126 to apply in later processes.

DFE 106 compares the identified media definitions against the attributes of all of the media in paper catalog 124. For example, referring to FIG. 3, first media definition 522 and second media definition 524 are compared to first attribute 312, second attribute 314, and third attribute 316 of each paper catalog entry 302 in paper catalog 124. If the media definition matches an attribute in the paper catalog entry, then DFE 106 may identify that paper catalog entry as being a media available to the printing operations of print job 103.

DFE 106 then compares the identified paper catalog entries to media catalog entries in media catalog 506. Media catalog 506 may be similar to a paper catalog in that it includes entries for media that is available for printing at printing device 104. Paper catalog 124 may include all the different types of defined papers of the media while media catalog 506 defines the actual media that is available for use. Paper catalog 124 may include entries with printing data for papers or media that is not available for printing at printing device 104, as set forth by media catalog 506. For example, paper catalog entry 302 may define a paper and its printing attributes along with print conditions, ICC profiles, calibrations, and the like but the paper trays at printing device 104 are not configured to print the media, as defined in media catalog 506, for the paper.

Based on these differences between paper catalog 124 and media catalog 506, the disclosed embodiments seek to only suggest media for papers having the defined media definitions that is available for printing at printing device 104. For example, DFE 106 may identify first media catalog entry 508, second media catalog entry 510, and third media catalog entry 512 as media that is applicable for print job 103. The media catalog entries support the defined media attributes. Thus, the media cited in list of papers 514 can be used to print document 105.

The disclosed embodiments may present an interactive message 516 to the operator that can be used by the operator to see the papers in list of papers 514. The operator may select a media from first media catalog entry 508, second media catalog entry 510, and third media catalog entry 512. The media catalog entries are determined to support print job 103. Thus, the disclosed embodiments use media attributes for the print job to automatically identify the media from media catalog 506.

In some embodiments, list of papers 514 may be generated from the entries in paper catalog 124 that match first media definition 522 and second media definition 524. Media catalog 506 may be bypassed. Each paper in list of papers 514 should include the respective attribute for the applicable media definitions.

The disclosed embodiments also may include policies to apply in identifying media catalog entries from media catalog 506. Policy 516 may include one or more tolerances 518. The tolerances relate to attribute tolerances, as disclosed in greater detail below. Using the matched media catalog entries from media catalog 506, DFE 106 generates a list of papers 514.

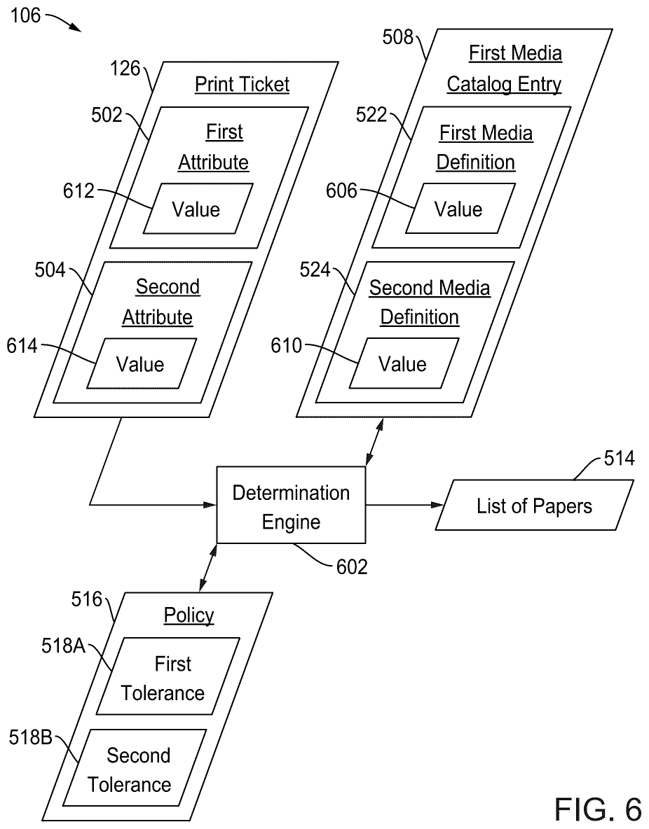

FIG. 6 depicts a block diagram of DFE 106 applying policy 516 to generate list of papers 514 according to the disclosed embodiments. Policy 516 includes tolerances 518 for the media definitions applicable in printing system 100 or defined for printing device 104. Policy 516 may be stored at DFE 106. Alternatively, policy 516 may be stored elsewhere in printing system 100 and accessible by DFE 106. In some embodiments, policy 516 may include first tolerance 518A and second tolerance 518B. First tolerance 518A may set forth tolerances for acceptable paper weight ranges for a paper or media. Second tolerance 518B may relate to acceptable ranges for paper size.

DFE 106 may use a determination engine 602 to determine whether a media catalog entry should be included in determining list of papers 514, which is presented to the operator or used for later processes in selecting a paper for print job 103. Determination engine 602 may compare each identified media catalog entry having the defined media definitions for print job 103 to determine whether papers associated with the media catalog entries should be included in list of papers 514. Determination engine 602 uses policy 516 to identify additional media entries that may be used in the printing operations.

For example, determination engine 602 may determine that only a couple media definitions match first media attribute 502 and second media attribute 504 of print ticket 126 based on the information within paper catalog 124. The disclosed embodiments would like to include a larger number of possible papers to be used for processing print job 103 so that the chance the paper suitable for the print job is loaded onto printing device 104 is increased. Print job 103 may be processed quicker and more efficiently using papers with media entries available at printing device 104 as opposed to having to load papers having the media definitions related to defined attributes.

The disclosed embodiments use policy 516 and tolerances 518 to expand the number of papers available for printing document 105 of print job 103. For example, first media definition 522 for first media catalog entry 508 may be paper weight, which corresponds to first tolerance 518A and first attribute 502. First media definition may have a value 606 of 216 gsm. First attribute 502 of print ticket 126 that specifies a value 612 that relates to a media definition of 220 gsm. Initially, determination engine 602 may determine that first media catalog entry 508 is not applicable for print job 103. Policy 516, however, is applied to determine whether value 606 is within first tolerance 518A.

First tolerance 518A may define that a given GSM value is acceptable as long as it is within a range, or tolerance. First tolerance 518A, for example, may define this range as 10% above or below the value for paper weight specified by print ticket 126. Thus, value 606 is within 10% of value 612. Determination engine 602 may determine that first media catalog entry 508 meets the criteria for paper weight. Attributes or media definitions having a numeric value may have tolerances defined as a percentage or range from the specified value in print ticket 126.

Alternatively, tolerances having a numeric value may be set at a maximum value, such as plus or minus 20 gsm from the specified attribute value in print ticket 126. Further, tolerances for numeric values may only include above or below the specified value. For example, first tolerance 518A may only accept values below the specified value, in which case value 606 of 216 gsm is still acceptable. If value 606 is 226 gsm, then determination engine 602 would not include first media catalog entry in determining list of papers 514.

Second attribute 504 of print ticket 126 for print job 103 may relate to paper size or dimensions. In this instance, use of ranges may not be practical. Second tolerance 518B of policy 516 may define how paper dimensions may be matched against media definitions in media catalog entries. For example, second tolerance 518B may specify that paper dimensions may be matched by selecting the smallest standard size paper that can contain the specified paper size by second attribute 504 of print ticket 126. Value 614 for second attribute 504 may be 8″×10″ paper dimensions.

Determination engine 602 then compares value 614 in view of second tolerance 518B to value 610 of second media definition 524 for first media catalog entry 508. Second media definition 524 for first media catalog entry 508 may be letter size, or 8.5″×11″, which does not exactly match value 614 of second attribute 504 for print job 103. Second tolerance 518B, however, specifies that the smallest standard paper size for printing device 104 that can capture the specified paper size is acceptable. Thus, determination engine 602 determines that second media definition 524 is acceptable for print job 103. Based on the determinations for first media definition 522 and second media definition 524, determination engine 602 may include first media catalog entry 508 in determining list of papers 514.

Policy 516 may include additional tolerances for additional media attributes. Attributes with an enumeration may be flexibly matched. Instead of numeric or size values, some attributes may be enumerated using terms or parameters. For example, supported attribute values may be marked as interchangeable, such as gloss and semi-gloss for papers. Unsupported attribute values may be mapped to supported values. For example, stipple or cockle textures may be mapped to supported texture attribute values. Further, some attributes may be ignored using policy 516. For example, an attribute for grain may be configured to always match any value in the media catalog entries regardless of what print ticket 126 specifies.

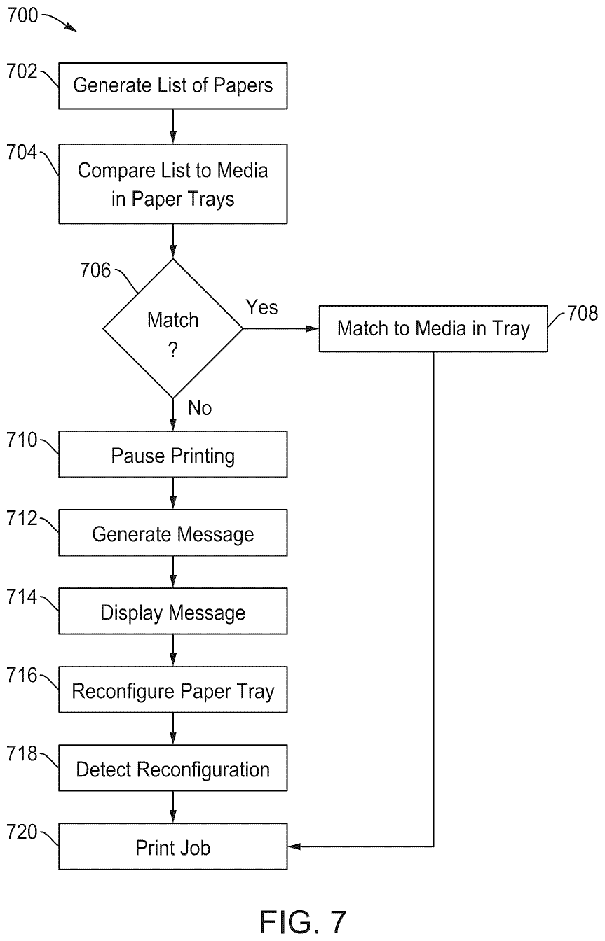

FIG. 7 depicts a flowchart 700 for configuring printing device 104 for printing using list of papers 514 according to the disclosed embodiments. Flowchart 700 may refer to FIGS. 1A-6 for illustrative purposes. Flowchart 700, however, is not limited to the embodiments disclosed by FIGS. 1A-6.

Step 702 executes by generating a list of papers 514 as disclosed above. List of papers 514 includes media catalog entries selected to be able to print document 105 for print job 103. For example, list of papers 514 may include papers from first media catalog entry 508, second media catalog entry 510, and third media catalog entry 512. These entries include media definitions that are acceptable for print job 103 as determined by DFE 106 based on the attributes specified in print ticket 126.

Step 704 executes by comparing list of papers 514 to the media or paper assigned to the paper trays loaded on printing device 104. Papers for the media may be within loaded paper trays. For example, second media catalog entry 510 may match paper 116 loaded in second paper tray 110. First media catalog entry 508 may not match any papers 114, 116, or 118 currently loaded on printing device 104.

Step 706 executes by determining whether a match exists between a media catalog entry in list 514 and papers loaded on printing device 104. If yes, then step 708 executes by matching print job 103 to the loaded paper. For example, second media catalog entry 510 matches paper 116. DFE 106 may match print job 103 to paper 116 in second paper tray 110. Once print job 103 matches to a specific media, the disclosed embodiments may not switch to another media, such as first media catalog entry 508 or third media catalog entry 512. The switch may not be made even if the other media would be acceptable in terms of matching first attribute 502 and second attribute 504. Flowchart 700 then proceeds to step 720 disclosed below.

If step 706 is no, then step 710 executes by pausing printing operations at printing device 104. If no media is assigned to a tray that matches list of media entries 514, then print job 103 stops. Step 712 executes by generating a message 516. Message 516 may let the operator know that acceptable media, or paper, is not available at printing device 104. Step 714 executes by displaying message 516 in user interface 120. Message 516 is an interactive message that can be used by the operator to see which papers for the media catalog entries may be loaded into a tray for printing device 104.

Step 716 executes by reconfiguring a paper tray at printing device 104 to include the paper selected or determined using list of media catalog entries 514. As noted above, the operator may see which papers may be loaded into a tray to complete print job 103. The operator may reconfigure a paper tray from message 516. This feature allows the operator to reconfigure trays from message 516 in DFE 106. Reconfiguration may be completed in various ways.

In some embodiments, the operator may open a tray and load the new paper. For example, the operator may open first paper tray 108 to load paper 114. User interface 120 may include a tray reconfiguration interface that automatically opens and shows the operator list of media entries 514. The operator selects one of the media and assigns it to the tray. Thus, the operator may assign paper 114 to first paper tray 108 to complete print job 103. Alternatively, the operator may bring up the tray reconfiguration user interface in user interface 120. List of papers 514 will be displayed to the operator, thereby allowing the operator to assign one of the media from the generated list to a paper tray. Printing system 100 or printing device 104 would reconfigure the paper and disable it for loading of the paper, such as paper 114 onto first paper tray 108.

Step 718 executes by detecting the reconfiguration of the paper tray. Preferably, detection is made when the operator opens the paper tray and closes it. For example, the operator is loading paper 114 onto first paper tray 108. Sensor 130 detects that paper tray 108 is opened. Sensor 130 then also detects when paper tray 108 is closed. Sensor 130 may send signal 131 to DFE 106 to reconfigure the paper tray with the loaded paper and resume printing operations. Step 720 executes by printing document 105 for print job 103 using the selected paper based on list of papers 514.

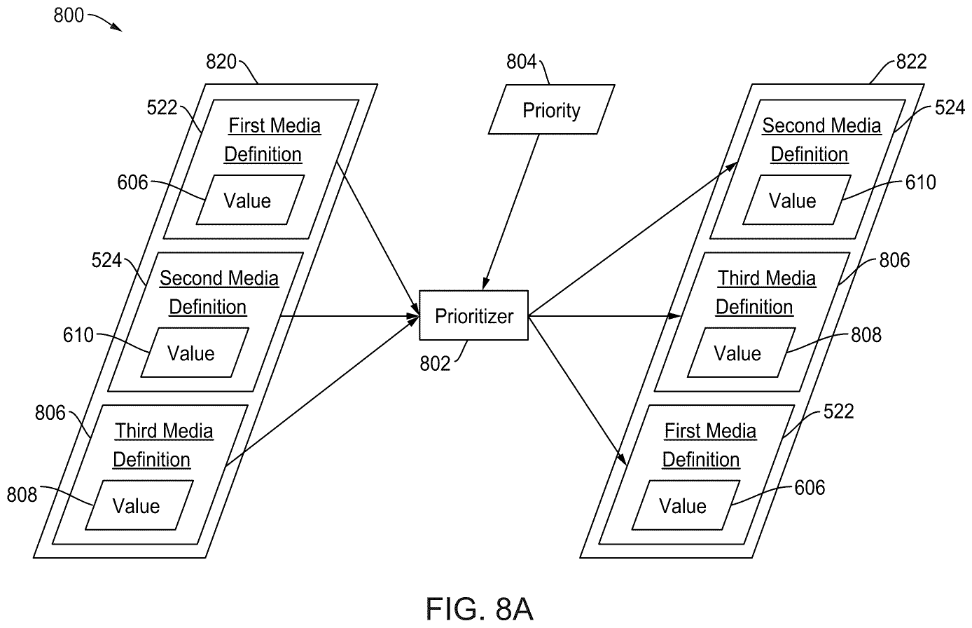

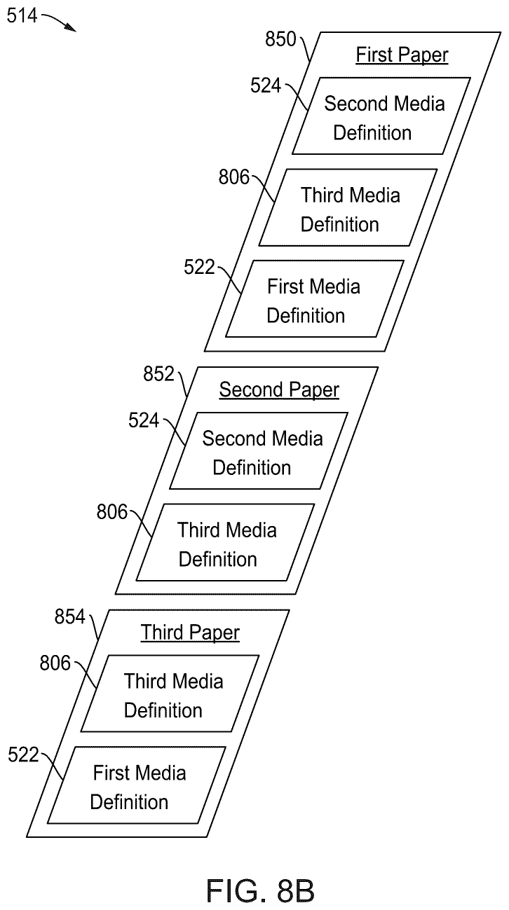

FIG. 8A depicts a block diagram of a prioritizing process 800 for media definitions according to the disclosed embodiments. Print ticket 126 may define first media definition 522, second media definition 524, and third media definition 806, shown as initial group of media definitions 820. First media definition 522 may have value 606, second media definition 524 may have value 610, third media definition 806 may have value 808. The media definitions may be used to prioritize the order of papers in list of papers 514. The media definitions, in turn, may be prioritized.

For example, if first media definition 522 relates to paper weight, then papers selected for list of papers 514 will be prioritized for operations, such as checking available papers in paper trays, according to attributes matching the media definition. Media definitions may be prioritized so that certain media definitions are used to list papers over other papers when accessing paper catalog 124 or media catalog 506. Using the above example, other attributes may be more important than paper weight, such as paper size.

The disclosed embodiments, therefore, may take into account priority 804 for media definitions associated with print jobs within print system 100 or at printing device 104. Priority 804 may be set forth in policy 516. Policy 516 may be associated to printing device 104, a customer account, first queue 140 or second queue 142, and the like. Alternatively, priority 804 may be a job setting, configuration setting, queue setting, and the like. Priority 804 also may be set forth in print ticket 126 using the order of attributes 128 listed therein.

Using the above examples, first media definition 522 may relate to paper weight as associated with attributes defining levels of paper weights, such as “Deluxe” or “heavy.” First media definition 522 may include value 606 that includes the paper weight for the media to be selected. Tolerances 518 may expand this number to a range or associated values to be considered in determining papers. Second media definition 524 may relate to paper size as associated with attributes such as “letter” or “legal.” Value 610 of second media definition 524 may include a size or dimensions for the paper. Third media definition 806 may relate to a media color, such as one specified by the paper manufacturer, as associated with attributes such as green, blue, and the like. Value 808 may include the specific name or names as defined by policy 516 for the paper.

Although first media definition 522, or associated attributes, may be listed first in print ticket 126, first media definition 522 may not be a higher priority in selecting papers for the job. For example, the customer for print job 103 may not care about weight or quality of the paper used as opposed to the size and media color. Having paper of a certain color and size is more important than its weight. Thus, priority 804 may prioritize paper size, media color, and paper weight, in that order.

Prioritizer 802 may receive the media definitions and priority 804 and reorder the media definitions for later operations. Using the priority order given above, prioritizer 802 may reorder the media definitions to second media definition 524 as having the highest priority, third media definition 806 as having the second highest priority, and first media definition 522 as the lowest priority. Thus, list of papers 514 may be ordered based on priority 804 as papers matching second media definition 524 are given the highest priority in matching to print job 103, as shown in prioritized media definitions 822.

In later operations, the disclosed embodiments may use the prioritized media definitions 822 to match papers in list of papers 514 with loaded papers in the paper trays, as disclosed above. For example, a paper of list of papers 514 having second media definition 524 that is loaded in a paper tray will be matched to print job 103 and print ticket 126. Thus, the disclosed embodiments may use multiple media definitions in automatically determining which paper to assign to a job.

FIG. 8B depicts a block diagram of list of papers 514 according to the disclosed embodiments. List of papers 514 is generated using media definitions along with entries from media catalog 506. Attributes related to print job 103 as set forth in print ticket 126 are compared to attributes listed for papers in paper catalog 124. Media definitions are used to enable flexible matching between these attributes. In other words, media definitions may specify how the attributes of print ticket 126 are compared to media attributes in paper catalog 124. Media definitions allow for an expansion of mapping job or system attributes to attributes in paper catalog 124 that enable some flexibility in paper selection.

For example, a first paper 850, a second paper 852, and a third paper 854 may be identified using media definitions 524, 806, and 522, as prioritized. Additional papers may be identified but FIG. 8B is limited to three for brevity. Papers may be ranked in order based on the prioritized media definitions. Using the example above, second media definition 524 has a higher priority than third media definition 806 and first media definition 522. Third media definition 806 has a higher priority than first media definition 522.

Thus, first paper 850 is “ranked” first as it has the value to meet value 610 of second media definition 524 along with value 808 of third media definition 806 and value 606 of first media definition 522. There may be more than one paper that meets these definitions, so that first paper 850 also may be a list of papers. In any selection process, first paper 850 may be considered first for printing operations of print job 103.

Second paper 852 may be ranked second as it has the value to meet value 610 of second media definition 524 along with value 808 of third media definition 806. Second paper 852 may not meet value 606 of first media definition 522. Thus, second paper 852 may be ranked lower than first paper 850. Again, there may be more than one paper listed as a “second” paper 852. Using the examples above, second paper 852 may not meet the value for paper weight as set forth by first media definition 522.

Third paper 854 may be ranked below first paper 850 and second paper 852 as it does not meet the value for second media definition 524. It does meet value 808 of third media definition 806 and value 606 of first media definition 522. These media definitions, however, are prioritized lower than second media definition 524 so that third paper 845 will be considered for printing operations after first paper 850 and second paper 852. Using the ordered list of papers, the disclosed embodiments may select a paper to use on printing device 104 for printing operations.

In some embodiments, list of papers 514 may include a list of media catalog entries having the papers associated with each entry. The disclosed embodiments may evaluate papers from the media catalog entries. The media catalog entries, such as first media catalog entry 508, second media catalog entry 510, and third media catalog entry 512, may include one or more papers and these papers are listed in list of papers 514. Further, the media catalog entries may be ranked according to priorities of the media definitions.

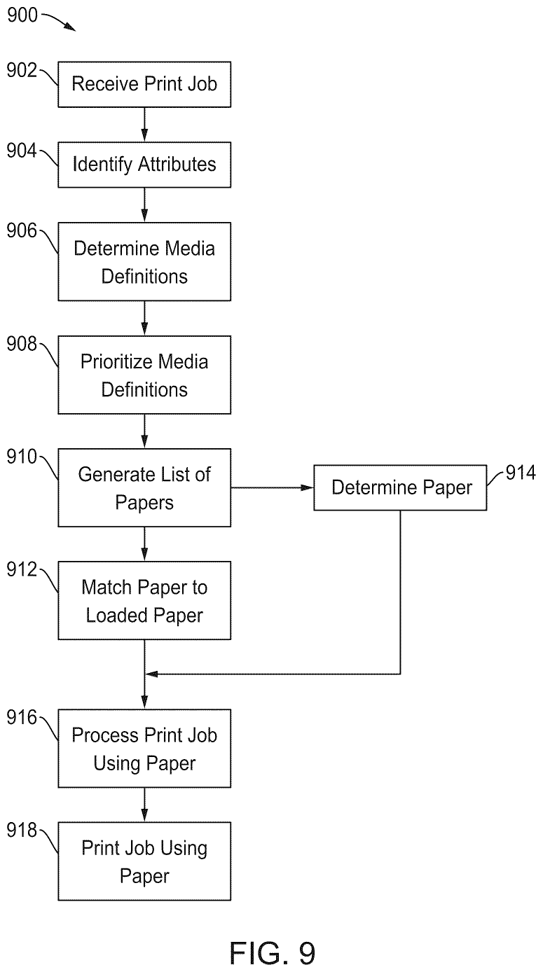

FIG. 9 depicts a flowchart 900 for using media definitions to determine list of papers 514 according to the disclosed embodiments. Flowchart 900 may refer to FIGS. 1A-8B for illustrative purposes. Flowchart 900, however, is not limited to the embodiments disclosed by FIGS. 1A-8B.

Step 902 executes by receiving print job 103 having print ticket 126 in printing system 100. Print job 103 may be assigned to printing device 104. Printing device 104 includes paper trays 108-112 that load papers 114-118. Additional papers may be loaded onto printing device 104 by switching out papers in the paper trays. Further, the number of papers that may be used in printing operations on printing device are much greater than the number of different papers loaded on printing device 104.

Step 904 executes by identifying attributes 128 from print ticket 126. As disclosed above, multiple attributes may be listed on print ticket 126 for print job 103. Attributes also may be applied to print job 103 from job settings, configuration settings, queue settings, system settings, and the like. Step 906 executes by determining a plurality of media definitions applicable to print job 103 based on the plurality of attributes 128. In some embodiments, media definitions may be included on print ticket 126 so that step 904 is not needed.

Step 908 executes by prioritizing the media definitions, as disclosed above. For example, the disclosed embodiments may determine that a first media definition 522, a second media definition 524, and a third media definition 808. Each media definition also may include a value for the media definition that is to be applied in selecting papers to use for the print job. Using priority 804, the disclosed embodiments may prioritize the media definitions to be second media definition 524, third media definition 808, and first media definition 522 in determining list of papers 514.

In some embodiments, a priority may be applied within the media definitions themselves. For example, if 10 papers fall within the weight threshold, then the disclosed embodiments may give priority to the paper that is closest to the gsm defined in the job setting. Similarly, the disclosed embodiments may give priority to the papers that are lighter within the tolerance as these papers may be cheaper. For settings such as glossy for the coating, which also may include satin or semi-gloss, the exact match should be higher priority than the other enumerated attributes. For example, papers having glossy may be a higher priority than satin or semi-gloss. Further, semi-gloss may be a higher priority than satin, especially if papers having a satin finish typically cost more.

Step 910 executes by generating list of papers 514 from media catalog 506 based on media definitions, 524, 808, and 522. Information from paper catalog 124 may be used in determining entries in media catalog 506 for selecting papers. Step 912 executes by matching a paper in list of papers 514 to a loaded paper on printing device 104 as disclosed above in flowchart 700. The order of matching papers may be set by the prioritized list of papers defined by the prioritized media definitions. Multiple media definitions may be used to select a paper for print job 103. As disclosed above, first paper 850 may be checked to papers currently loaded on printing device 104 to see if there is a match. If not, then second paper 852 may be considered, and so on.

In some instances, a paper loaded onto printing device 104 may not match a paper within list of papers 514. In other embodiments, the operator may select a paper from list of papers 514. Thus, step 914 may execute instead of, or in conjunction with, step 912 to determine a paper to use in printing operations from list of papers 514. The determination may occur automatically based on the papers listed in list of papers 514. As disclosed above, first paper 850, second paper 852, and third paper 854 may be displayed with list of papers 514 so that the operator can select a paper to use.

Step 916 executes by processing print job within DFE 106 using the information, including paper catalog information, for the determined paper. Color conversion and other operations may be executed to generate the data for printing document or documents for print job 103. Step 918 executing by printing print job 103 using the selected paper based on the media definitions.

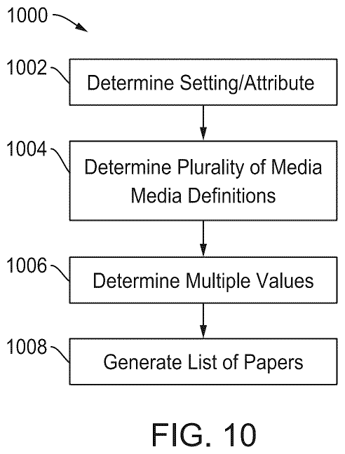

FIG. 10 illustrates a flowchart 1000 for applying a setting or attribute having multiple values to generate list of papers 514 according to the disclosed embodiments. Flowchart 1000 may refer to FIGS. 1A-9 for illustrative purposes. Flowchart 1000, however, is not limited to the embodiments disclosed by FIGS. 1A-9.

Step 1002 executes by determining a setting or attribute applicable to print job 103 and print ticket 126. The setting may be related to an attribute listed in print ticket 126. Settings may refer to job settings, system settings, or queue settings. These settings may be used in later steps. Settings also may relate to attributes that are linked to job types. Job types may be defined as, for example, business cards or postcards. Print ticket 126 may specify a job type attribute for postcards. Job types also may be narrowly defined as, for example, basic business cards, standard business cards, premium business cards, or extra thick business cards. These features may still require media attributes on print ticket 126 but also an indication of the job type.

Alternatively, these embodiments may be configured wholly within printing system 100 so that print ticket 126 specifies the job type and the system would be configured with expected attributes and the values for the attributes. This feature would allow the disclosed embodiments to not consider anything other than the type of job that the customer ordered. Determination of acceptable papers would be done completely within the printing system.

Step 1004 executes by determining a plurality of media definitions based on the attribute or setting applicable to print job 103. Step 1006 executes by determining multiple values for the media definitions related to the setting or attribute. As disclosed above, ranges may be defined for multiple values of a media definition based on multiple values applicable to the setting or attribute. These ranges may be defined by tolerances, either according to the settings or policy 516.

For example, numeric attributes may reference an acceptable range instead of a specific value. This feature may transfer over to media definitions. For example, first attribute 502 may relate a first media definition 522, which is paper weight. Using the attribute or setting, first media definition 522 may include a range of acceptable values such as 100-120 gsm instead of 110 gsm as an acceptable paper weight. Enumerated attributes may reference a set of values instead of a specific value, which is used as values for the media definition. For example, paper coating may be defined as “satin,” “semi-gloss,” and “glossy” instead of “glossy.”

Step 1008 executes by generating list of papers 514 based on the multiple values for the media definitions. When the disclosed embodiments receive a print ticket 126 with multi-value attributes 128, they will generate a list of papers 514, or list of media catalog entries, that match at least one of the attribute ranges. For example, first paper 850 may have values for media definitions or attributes of 110 gsm, semi-gloss, white, and letter while second paper 852 may have values for media definitions or attributes of 100 gsm, glossy, white, and letter. If any of the papers from list of papers 514 is loaded, then print job 103 will match to that paper for printing operations.

Tolerances and equivalents may be defined as system settings or queue settings corresponding to first queue 140 or second queue 142. Numeric attributes or media definitions may be defined with a tolerance 518, such as +/−10 gsm. In this instance, a paper that is 100 gsm may match to papers that are 90-110 gsm. Alternatively, these papers may be defined as weight ranges so that a 100 gsm paper may, for example, match papers that are 100-120 gsm. Enumerated attributes or media definitions may be defined with equivalences, for example, “satin” may be equivalent to “semi-gloss” and “glossy.” In this instance, a paper that is glossy may match to satin or semi-glossy but not to high gloss or uncalendared papers.

Thus, according to the disclosed embodiments, multiple values for attributes may be defined that are used with the media definitions to generate list of papers 514. This list of papers then may be used to select or match a paper for an incoming print job based on the information provided with the print ticket.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations, the method comprising:
receiving a print job for a printing device, wherein the print job includes a print ticket;
determining a plurality of media definitions for the print job from the print ticket, wherein each media definition of the plurality of media definitions corresponds to an attribute within a paper catalog for the printing device;
generating a list of papers for the print job from a media catalog for the printing device based on the plurality of media definitions, wherein each paper includes the respective attribute for the applicable media definition;
determining a paper of the list of papers to assign to the print job; and
processing the print job using the paper.

2. The method of claim 1, further comprising prioritizing the plurality of media definitions.

3. The method of claim 2, wherein prioritizing the plurality of media definitions includes assigning a priority to each media definition of the plurality of media definitions.

4. The method of claim 2, wherein prioritizing the plurality of media definitions includes prioritizing based on an order of the plurality of media definitions listed in the print ticket.

5. The method of claim 2, further comprising ordering the list of papers according to the priority for the respective media definition.

6. The method of claim 5, wherein determining the paper is based on the ordered list of papers.

7. The method of claim 1, wherein determining the paper includes matching the paper from the list of papers to a loaded paper at the printing device.

8. The method of claim 1, wherein determining the paper includes selecting the paper from the list of papers.

9. A method for managing printing operations, the method comprising:
receiving a print job for a printing device, wherein the print job includes a print ticket having at least one attribute having multiple values;
determining a plurality of media definitions for the print job from the print ticket, wherein each media definition of the plurality of media definitions includes a value of the multiple values for the at least one attribute;
generating a list of papers for the print job from a media catalog for the printing device based on the plurality of media definitions;
determining a paper of the list of papers to assign to the print job; and
processing the print job using the paper.

10. The method of claim 9, further comprising prioritizing the plurality of media definitions.

11. The method of claim 10, wherein prioritizing the plurality of media definitions includes assigning a priority to each media definition of the plurality of media definitions.

12. The method of claim 10, wherein prioritizing the plurality of media definitions includes prioritizing based on an order of the plurality of media definitions listed in the print ticket.

13. The method of claim 10, further comprising ordering the list of papers according to the priority for the respective media definition.

14. The method of claim 13, wherein determining the paper is based on the ordered list of papers.

15. The method of claim 9, wherein determining the paper includes matching the paper from the list of papers to a loaded paper at the printing device.

16. The method of claim 9, wherein determining the paper includes selecting the paper from the list of papers.

17. The method of claim 9, wherein the multiple values of the at least one attribute includes a range of values.

18. The method of claim 9, wherein the multiple values of the at least one attribute includes different attribute types.

19. A method for assigning a paper to a print job at a printing device, the method comprising:
determining media definitions for the print job based on a print ticket having at least one attribute;
generating a list of media catalog entries from a paper catalog based on the media definitions for the print job;
selecting a paper from the list of media catalog entries, wherein the paper includes the at least one attribute;
assigning the paper to the print job; and
printing the print job at the printing device using the paper.

20. The method of claim 19, further comprising prioritizing the list of media catalog entries.
